(19) United States
(12) Patent Application Publication
(10) Pub. No.: US 2025/0319821 A1
(43) Pub. Date: Oct. 16, 2025

(54) CONSOLE FOR A VEHICLE AND A VEHICLE

(71) Applicant: Ford Global Technologies, LLC, Dearborn, MI (US)

(72) Inventors: Adam Wang, Jiangning (CN); Joy Yu, Nanjing (CN); Lillian Long, Nanjing (CN); Zhiqiang Xu, Nanjing (CN)

(73) Assignee: Ford Global Technologies, LLC, Dearborn, MI (US)

(21) Appl. No.: 19/077,102

(22) Filed: Mar. 12, 2025

(30) Foreign Application Priority Data
Apr. 12, 2024 (CN) 2024104451672

(51) Int. Cl. B60R 7/04; B60N 2/75

(52) U.S. Cl. CPC B60R 7/04; B60N 2/793

(57) ABSTRACT

A console for a vehicle comprises a body with a top opening, a lid configured to move between a first position, in which the top opening is closed, and a second position, in which the top opening is at least partially exposed, and a guiding assembly engaged between the body and the lid. The guiding assembly includes a first guiding rod and a second guiding rod that are spaced apart, and the first guiding rod has an arc-shaped segment and is configured to pivot around a first pivot end to move the lid from the first position to the second position.

### CROSS-REFERENCE TO RELATED APPLICATION

This application claims foreign priority benefits under 35 U.S.C. § 119(a)-(d) to China Application No. 2024104451672 filed Apr. 12, 2024, which is hereby incorporated by reference in its entirety.

### FIELD OF THE DISCLOSURE

The present disclosure generally relates to vehicles, and more particularly relates to a console for a vehicle and a vehicle having the console.

### BACKGROUND OF THE DISCLOSURE

Some vehicle consoles generally include a body with a top opening and a corresponding lid that can move between a first position and a second position. When in the first position, the lid closes the top opening to hide storage items located below the top opening and can be used as an armrest. When in the second position, the lid at least partially exposes the top opening, allowing a user to access the storage items contained below the top opening, and the lid in the second position can also be used as a table. It would be desirable to provide for a vehicle console that offers convenient movement of the lid with guiding assemblies that operate efficiently.

### SUMMARY OF THE DISCLOSURE

According to a first aspect of the present disclosure, a console for a vehicle comprises a body with a top opening, a lid configured to move between a first position, in which the top opening is closed, and a second position, in which the top opening is at least partially exposed, and a guiding assembly engaged between the body and the lid. The guiding assembly includes a first guiding rod and a second guiding rod that are spaced apart, and the first guiding rod has an arc-shaped segment and is configured to pivot around a first pivot end to move the lid from the first position to the second position.

Embodiments of the first aspect of the present disclosure can include any one or a combination of the following features:
the first guiding rod has an approximately U-shaped cross-section;
the arc-shaped segment is configured to move along an arc-shaped path that is at least partially consistent with the arc-shaped segment;
the arc-shaped segment has a central angle in the range of about 70 degrees to about 90 degrees;
the body comprises a first receiving groove for receiving the first guiding rod, and the first receiving groove is spaced apart from the top opening in a length direction of the vehicle;
the first receiving groove has a first opening with a dimension smaller than a dimension of the first receiving groove in the length direction;
the body comprises a second receiving groove for receiving the second guiding rod, and the first receiving groove is spaced apart from the second receiving groove in the length direction or the first receiving groove and the second receiving groove have an overlapping size smaller than a predetermined value;
the first receiving groove has a dimension smaller than a dimension of the second receiving groove in the length direction;
the guiding assembly comprises two second guiding rods arranged opposite each other in a width direction of the vehicle;
the body comprises two second receiving grooves for receiving the two second guiding rods, and the top opening is located between the two second receiving grooves in the width direction;
the first receiving groove is located between the two second receiving grooves in the width direction;
the lid is configured to close the first receiving groove and the second receiving groove when in the first position;
covering members are provided at the openings of the first receiving groove and the second receiving groove;
the second guiding rod is a straight rod and configured to pivot around a second pivot end, and the first pivot end of the first guiding rod and the second pivot end of the second guiding rod are arranged at the same height;
the second guiding rod has a length equal to a radius of the arc-shaped segment of the first guiding rod;
a driving mechanism for promoting movement of the guiding assembly and a deceleration mechanism connected between the driving mechanism and the guiding assembly;
the lid comprising a base panel and a side panel pivotably connected to the base panel;
a cushioning component is provided at a bottom of the lid; and
a storage area is spaced apart from the lid, and the arc-shaped segment does not interfere with items in the storage area during the movement of the lid.

According to a second aspect of the present disclosure, a vehicle comprises a cabin interior and a console located in the cabin interior. The console comprises a body with a top opening, a lid configured to move between a first position, in which the top opening is closed, and a second position, in which the top opening is at least partially exposed, and a guiding assembly engaged between the body and the lid. The guiding assembly includes a first guiding rod and a second guiding rod that are spaced apart, and the first guiding rod has an arc-shaped segment and is configured to pivot around a first pivot end to move the lid from the first position to the second position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper rear perspective view of a cabin interior of a vehicle with a console according to an embodiment of the present disclosure;

FIG. 2 is an upper rear perspective view of the console according to an embodiment of the present disclosure;

FIG. 3 is a partial upper perspective view of the console according to an embodiment of the present disclosure;

FIG. 4 is a top view of a body of the console according to an embodiment of the present disclosure;

FIG. 5 is a schematic side view of a lid of the console in a first position according to an embodiment of the present disclosure;

FIG. 6 is a schematic side view of the lid of the console in a second position according to an embodiment of the present disclosure;

FIG. 7 is a schematic side view of motion paths of a first guiding rod and a second guiding rod according to an embodiment of the present disclosure;

FIG. 8 is a schematic side view of the lid of the console in the first position according to another embodiment of the present disclosure; and

FIG. 9 is a schematic side view of the lid of the console in the second position according to another embodiment of the present disclosure.

### DETAILED DESCRIPTION OF PREFERRED EMBODIMENTS

Reference will now be made in detail to the present preferred embodiments of the

disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

Embodiments of the present disclosure are described below. However, it is to be understood that the disclosed embodiments are merely examples and other embodiments may take various and alternative forms. The figures are not necessarily to scale; and some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

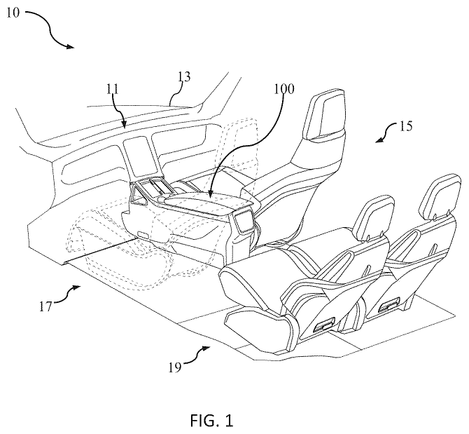

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a console for a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

In the present disclosure, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another clement or part, the intervening elements or parts may not be present. Other words used to describe the relationship between elements should be interpreted in a like fashion.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

FIG. 1 illustrates a vehicle 10, such as a motor vehicle, with a console 100 according to an embodiment of the present disclosure. The vehicle 10 has a vehicle interior 11, which includes a passenger compartment 15 accommodated within a vehicle body 13. The passenger compartment 15 may include a first row of seats 17 and a second row of seats 19. Without departing from the teachings of this application, the passenger compartment 15 may include fewer or more row of seats. The first row of seats 17 may include a driver seat and a passenger seat. The driver seat and the passenger seat can be separated by the console 100. The second row of seats 19 may include rear passenger seats. The rear passenger seats of the second row of seats 19 can include a bucket seat or can be a bench. The console 100 can also be arranged between the rear passenger seats. Although the console 100 is shown arranged between the driver seat and the passenger seat, the present disclosure is not limited to this arrangement, and the console 100 can be arranged at various positions throughout the vehicle 10. Without departing from the teachings of the present application, the console 100 may be arranged between the driver seat and the passenger seat, between the first and second rear seats, or at any feasible position within the passenger compartment 15 of the vehicle interior 11.

In various examples, the vehicle 10 may be a standard gasoline powered vehicle, a hybrid electric vehicle (HEV), an electric vehicle (BEV), a plug-in hybrid electric vehicle (PHEV), a fully hybrid electric vehicle (FHEV), a fuel cell vehicle, and/or any other type of vehicle, and may also be a bus, ship, or aircraft. The vehicle 10 includes components related to maneuverability, such as engine, electric motor, transmission, suspension, driveshaft, and/or wheels. The vehicle 10 can be non-autonomous, semi-autonomous (for example, some conventional motion functions are controlled by the vehicle), or autonomous (for example, motion functions are controlled by the vehicle without direct input from driver).

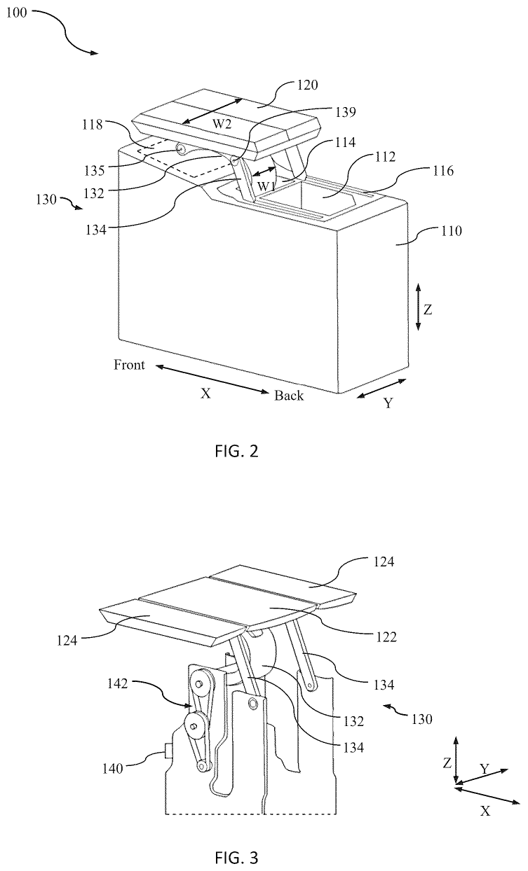

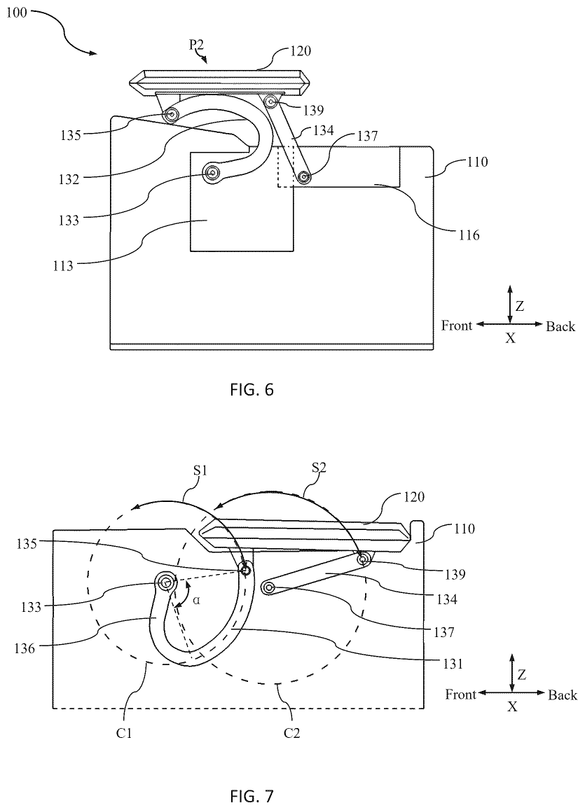

Referring to FIGS. 2, 5, and 6, in some embodiments of the present disclosure, the console 100 includes a body 110 with a top opening 112, a lid 120, and a guiding assembly 130 engaged between the body 110 and the lid 120. The lid 120 is configured to move between a first position P1 (as shown in FIG. 5) and a second position P2 (as shown in FIG. 6), in the first position P1, the top opening 112 is closed, and in the second position P2, the top opening 112 is at least partially exposed. The guiding assembly 130 is configured to guide the lid 120 to move from the first position P1 to the second position P2 or from the second position P2 to the first position P1.

The body 110 can be provided with a storage chamber for storing items. The storage chamber has the top opening 112. The items inside the storage chamber can be conveniently placed or accessed through the top opening 112. The storage chamber and the body 110 can be integrally formed, or can also be combined together after being separately formed. The storage chamber can be fixed to the body 110 through methods such as welding and bonding, or can also be detachably installed on the body 110 through methods such as threaded connection, clamping, pressing, and clamping. The storage chamber can have a regular shape such as a cube, or it can also be designed with an irregular shape such as a slope, concave surface, or convex surface. The storage chamber can have a larger depth in a height direction Z of the vehicle to provide sufficient storage space for large-sized items (such as beverage bottles and other slender items). In some embodiments, the depth of the storage chamber along the height direction Z may have a ratio in the range of 1/2 to 3/4 to the height of the body 110 along the height direction Z.

As shown in FIG. 5, the lid 120 is in the first position P1, which can be a storage position of the lid 120. When in the first position P1, the lid 120 closes the top opening 112 to conceal and protect the storage chamber and items inside it. Meanwhile, the lid 120 in the first position Pl can also be used as an armrest for driver or passenger to rest and relax their arms. When in the first position P1, the lid 120 can be attached to a surface near the top opening 112 so that the lid 120 covers a top surface of the body 110, or the lid 120 can be embedded in the top opening 112 so that the top surface of the lid 120 is flush with the top surface of the body 110. When the lid 120 is in the first position P1, the guiding assembly 130 can be hidden inside the body 110, ensuring that the console 100 has a beautiful appearance and providing protection for the guiding assembly 130. In some embodiments, a scaling component (such as a sealing ring, scaling strip) may be provided at the bottom of the lid 120, or a sealing component may be provided around the top opening 112, so that when the lid 120 is in the first position P1, the top opening 112 can be sealed by the sealing component to prevent dust from entering the body 110 from the top opening 112. In some embodiments, a cushioning component (such as rubber, soft pad) may be provided at the bottom of the lid 120, so that when the lid 120 moves from the second position P2 to the first position P1, it can gently and flexibly engage with the body 110.

As shown in FIG. 6, the lid 120 is in the second position P2, which can be a support position of the lid 120. When in the second position P2, the lid 120 at least partially exposes the top opening 112, allowing the items inside the storage chamber to be accessed by the user or placed inside the storage chamber by the user. Meanwhile, the lid 120 in the second position P2 can also serve as a tabletop for vehicle occupants to use in a comfortable position. For example, in some embodiments, the second position P2 may have a forward displacement in a length direction X of the vehicle and an upward displacement in the height direction Z of the vehicle relative to the first position P1, so that the lid 120 in the second position P2 is closer to driver and front passengers, making it easier for the driver or front passengers to use the lid 120 as a tabletop in a comfortable position, such as placing handheld devices such as laptops, tablets, smartphones, etc. on the lid 120 for office or entertainment activities. Of course, in other embodiments, the second position P2 may also have a backward displacement in the length direction X and an upward displacement in the height direction Z relative to the first position P1, so that the lid 120 in the second position P2 is closer to the rear passengers. The relative displacement between the second position P2 and the first position P1 can be set based on the relative position between the seats and the console 100, as well as the comfortable position of the vehicle occupants.

As shown in FIG. 3, the lid 120 can further have an unfolded position. In some embodiments, the lid 120 includes a base panel 122 and a side panel 124 pivotably connected to the base panel 122. The side panel 124 has an unfolded state as shown in FIG. 3 and a folded state as shown in FIG. 2. One or more side panels 124 can be provided. Referring to FIG. 3, the lid 120 may include two side panels 124 arranged on opposite sides of the base panel 122. Unfolding the side panels 124 can further expand the usable area of the lid 120, while folding the side panels 124 is beneficial for the storage of the lid 120. The side panel 124 can have a width approximately half the width of the base panel 122. The side panel 124 can be manually driven to pivot for unfolding or folding, or a corresponding driving mechanism 140 can be configured to automatically drive the side panel 124 to pivot. When the lid 120 moves to the second position P2, the side panel 124 can be manually or automatically unfolded to obtain a larger usable area. When it is necessary to retract the lid 120 to the first position P1, the side panel 124 can be folded first, and then the lid 120 can be controlled to move towards the first position P1.

Referring to FIGS. 2, and 5-7, in some embodiments of the present disclosure, the guiding assembly 130 includes a first guiding rod 132 and a second guiding rod 134 spaced apart. The first guiding rod 132 has an arc-shaped segment 131 and is configured to pivot around a first pivot end 133 to move the lid 120 from the first position P1 to the second position P2. The first guiding rod 132 has a first engagement end 135 opposite to the first pivot end 133. The first engagement end 135 forms a part of the arc-shaped section 131 and is joined to the lid 120, for example, it can be pivotably connected to the lid 120 through a pin or it can be pivotably connected to a connecting piece provided at the bottom of the lid 120. The first guiding rod 132 rotates around its first pivot end 133, allowing the first engagement end 135 to move along a predetermined arc-shaped path S1 on the circle around the first pivot end 133, thereby guiding the lid 120 to smoothly move along the arc-shaped path. Through such movement, the displacement of the lid 120 in the length direction X and the height direction Z can be directly and one-step achieved, thereby conveniently guiding the lid 120 from the first position P1 to the desired second position P2, without the need for separate movements in the length and height directions.

Referring to FIGS. 5-9, the first guiding rod 132 may have an approximately U-shaped cross-section, such as a roughly C-shaped cross-section or may be formed in the shape of a goose neck. By designing the first guiding rod 132 with the arc-shaped section 131, interference between the first guiding rod 132 and the body 110 during its rotation can be reduced. Compared to a straight rod, the shape of the first guiding rod 132 prevents contact with the body 110 during its rotation around the first pivot end 133, reducing the occupation of space and/or adverse effects on the functionality of the body 110.

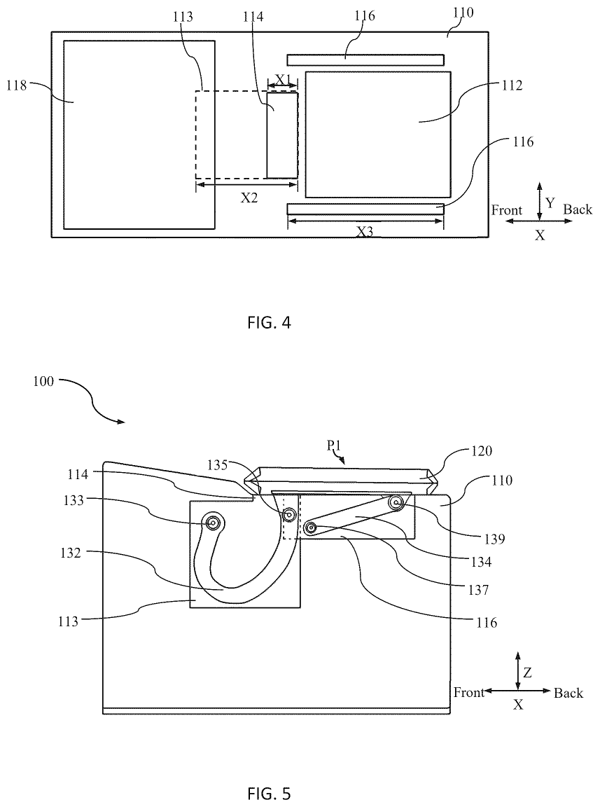

Referring to FIG. 7, in some embodiments, the arc-shaped segment 131 is configured to move along the arc-shaped path S1 that is at least partially consistent with the arc-shaped segment 131. The arc-shaped segment 131 and the arc-shaped path S1 can be located on the same circle C1, with the same center and radius. In this way, the area where the first guiding rod 132 interferes with the body 110 during rotation can be minimized to the greatest extent possible. During the process of guiding the lid 120 from the first position P1 to the second position P2 with the arc-shaped segment 131, the arc-shaped segment 131 gradually passes through the top surface of the body 110. As the arc-shaped segment 131 moves along the arc-shaped path S1 that is concentric with it, the area where the arc-shaped segment 131 may interfere with the body 110 is always a small area where the circle C1 of the arc-shaped segment 131 intersects with the top surface of the body 110. By forming a small opening at this area (such as a first opening 114 shown in FIG. 4), the arc-shaped segment 131 of the first guiding rod 132 can be allowed to pass through. In some embodiments, the first opening 114 may have dimensions that match the thickness along the length direction X and the width along a width direction Y of the first guiding rod 132, or have dimensions that match the cross-section of the first guiding rod 132. Here “match” can indicate that the dimensions are equivalent or the dimension of the first opening 114 is slightly larger than the dimension of the first guiding rod 132 by a predetermined margin.

It should be appreciated by those skilled in the art that for the circle C1 where the arc-shaped segment 131 and the arc-shaped path S1 are located, the center position (i.e., the position of the first pivot end 133 of the first guiding rod 132) and radius size (e.g., the linear distance between the first pivot end 133 and the first engagement end 135 of the first guiding rod 132) of the circle can be designed based on the expected displacement of the lid 120 in the length direction X and height direction Z, the dimension of the body 110, and the position of the storage chamber. In some embodiments, the center of the circle is spaced apart from the storage chamber in the length direction X and the distance from the center to the storage chamber is greater than the radius of the circle, so that the circle is spaced apart from the storage chamber in the length direction X, and the first guiding rod 132 does not interfere with the storage chamber during the process of guiding the movement of the lid 120. That is to say, the storage chamber and the movable range of the first guiding rod 132 can be spaced apart in the length direction X without affecting each other. For example, in some embodiments, the storage chamber is arranged in the rear area of the body 110, and the first guiding rod 132 is arranged in the front area of the body 110 and is movable within the front area.

Referring to FIGS. 5-7, the first pivot end 133 of the first guiding rod 132 is located at the center of the circle C1 where the arc-shaped section 131 is located. The first guiding rod 132 also includes an extension section 136 that extends from the first pivot end 133 to the arc-shaped section 131, allowing the arc-shaped section 131 to move along the arc-shaped path S1 that is concentric with it. The extension segment 136 can be curved and smoothly transition with the arc-shaped segment 131. The arc-shaped segment 131 located on the circle and the extension segment 136 extending from the center of the circle to the arc-shaped segment 131 together form the approximately U-shaped shape. The first guiding rod 132 can be an integral component to achieve structural smoothness.

Referring to FIG. 7, in some embodiments, the arc-shaped segment 131 has a central angle α in the range of about 70 degrees to about 90 degrees. The central angle can guide the lid 120 from the first position P1 to the desired second position P2 and adopt an appropriate arc length, which may be beneficial for manufacturing the first guiding rod 132 that meets the requirements with appropriate materials and efficiencies.

Referring to FIG. 2, the first guiding rod 132 has a width W1 in the width direction Y, the lid 120 (when folded) has a width W2 in the width direction Y, the ratio of W1 to W2 can be in the range of about 50% to about 70%, for example, can be about 60%. The wider first guiding rod 132 can provide more stable guidance and support. The number of the first guiding rods 132 can be one and the first guiding rods 132 is arranged in the middle area of the lid 120 along the width direction Y. Of course, in other embodiments, the number and width of the first guiding rods 132 can also be adjusted according to the situation. For example, two or more first guiding rods 132 can be arranged along the width direction Y, and the width of each first guiding rod 132 can be smaller.

Referring to FIGS. 2-3 and 5-7, in some embodiments, the second guiding rod 134 is a straight rod and configured to pivot around a second pivot end 137. The second guiding rod 134 has a second engagement end 139 opposite to the second pivot end 137, and the second engagement end 139 is engaged to the lid 120, for example, it can be pivotably connected to the lid 120 through a pin or connected to a connecting piece fixed at the bottom of the lid 120. The second guiding rod 134 can move around the second pivot end 137 along a predetermined arc-shaped path S2 located on a circle C2, thereby guiding the joint on the lid 120 to also move along the arc-shaped path S2. The second guiding rod 134 can synergistically assist in the movement of the lid 120. For example, when the first guiding rod 132 guides the movement of the lid 120, the second guiding rod 134 moves together, playing a role in assisting in guiding the movement of the lid 120 and supporting the lid 120.

Through the guiding assembly 130 of this application, the lid 120 can be moved a significant distance in the length direction X to the desired second position P2, and the top opening 112 can be exposed as much as possible for accessing the items in the storage chamber.

Referring to FIGS. 5 and 6, the first guiding rod 132 and the second guiding rod 134 can be respectively joined to the opposite side areas of the lid 120 in the length direction X (for example, the first guiding rod 132 is joined to the front area of the lid 120, and the second guiding rod 134 is joined to the rear area of the lid 120), to stably guide the movement of the lid 120 through multiple joints.

Referring to FIG. 2, in some embodiments, the guiding assembly 130 includes two second guiding rods 134 arranged opposite each other in the width direction Y of the vehicle. Through such arrangement, on the one hand, it is beneficial to guide and support the lid 120 more stably, and on the other hand, it is beneficial to prevent mutual interference between the second guiding rod 134 and the storage chamber. Specifically, the two second guiding rods 134 can be respectively joined to both sides of the lid 120 along the width direction Y, while the first guiding rod 132 can be joined to the middle of the lid 120 along the width direction Y, and the three joints form a stable triangular structure to provide stable guidance and support for the lid 120. Moreover, the two second guiding rods 134 can be respectively arranged on both sides of the top opening 112 along the width direction Y, thereby preventing mutual interference between the second guiding rod 134 and the top opening 112 during the process of guiding the movement of the lid 120.

Referring to FIG. 3, in some embodiments, the console 100 further includes a driving mechanism 140 for promoting the movement of the guiding assembly 130, and a deceleration mechanism 142 connected between the driving mechanism 140 and the guiding assembly 130. By providing the deceleration mechanism 142 to achieve the purpose of deceleration, it ensures that the lid 120 can move relatively smoothly, preventing the lid 120 from suddenly lifting too quickly and affecting the user experience. The driving mechanism 140 can be connected to either or all of the first guiding rod 132 and the second guiding rod 134 through the deceleration mechanism 142. For example, the driving mechanism 140 can be connected to the first pivot end 133 of the first guiding rod 132 through the deceleration mechanism 142 and drive the first guiding rod 132 to pivot around the first pivot end 133, thereby driving the second guiding rod 134 to pivot around the second pivot end 137. In other feasible embodiments, the driving mechanism 140 can also drive the second guiding rod 134, or synchronously drive the first guiding rod 132 and the second guiding rod 134. The driving mechanism 140 may include a motor 142. The console 100 may also include control buttons located on the body 110. The control buttons are configured to control the motor 142 to rotate in a predetermined direction to drive the lid 120 to move from the first position P1 to the second position P2, or from the second position P2 to the first position P1.

FIG. 4 shows a top view of the body 110 of the console 100 according to an embodiment of the present disclosure. Referring to FIGS. 4-6, the body 110 includes a first receiving groove 113 for receiving the first guiding rod 132. When the lid 120 is in the first position P1, the first guiding rod 132 can be fully accommodated in the first receiving groove 113, providing protection for the first guiding rod 132 and giving the console 100 an aesthetic appearance. The first receiving groove 113 and the top opening 112 are spaced apart from each other in the length direction X of the vehicle, and the first guiding rod 132 received in the first receiving groove 113 will not interfere with the top opening 112 or invade the storage chamber.

Referring to FIGS. 4-6, the first receiving groove 113 has the first opening 114, and the first opening 114 is formed on the top surface of the body 110 for the first guiding rod 132 to pass through when it moves. As shown earlier, the structural design of the first guiding rod 132 ensures minimal interference between it and the body 110 during its movement. By forming a small-sized first opening 114 on the top surface of the body 110, it is possible to meet the need for the first guiding rod 132 to pass through, minimizing its occupation or functional effect on the top surface of the body 110. The first opening 114 has a dimension X1 in the length direction X, which matches the thickness of the first guiding rod 132, and X1 may be smaller than the dimension X2 of the first receiving groove 113.

The smaller first opening 114 enables smooth closure of the first opening 114 when the lid 120 is in the first position P1, further improving the appearance of the console 100 and reducing the chance of dust entering from the first opening 114. It should be appreciated that one of ordinary skill in this art can understand that if there is significant interference between the first guiding rod 132 and the body, a large opening needs to be opened on the top surface of the body, which may exceed the range that the lid 120 in the first position can cover, resulting in the inability to close the opening in the storage state of the lid 120, affecting the aesthetic appearance and facing a greater chance of falling dust. The first opening 114 and the top opening 112 can be relatively close in the length direction X, so that when the lid 120 closes the top opening 112, it can also close the first opening 114. In further embodiments, a covering member (such as a dust cover or dust ring made of rubber, soft cloth, etc.) can be provided at the first opening 114 to cover the gap between the first guiding rod 132 and the first opening 114 as much as possible when the first guiding rod 132 passes through the first opening 114, thereby achieving dust prevention.

Referring to FIGS. 2 and 4, in some embodiments, the console 100 further includes a storage area 118 spaced apart from the lid 120. The storage area 118 can be used to arrange buttons, cup holders, and/or store other items. The first opening 114 with a smaller extension range in the length direction X can be spaced apart from the storage area 118 in the length direction X without interfering with the storage area 118. For example, the first opening 114 can be located in the middle area of the top surface of the body 110, while the storage area 118 is located on one side of the top surface of the body 110 in the length direction X (such as the front area). In the embodiment of the present disclosure, the structural design of the first guiding rod 132 can reduce its interference with the body 110 during movement, and the arc-shaped section 131 of the first guiding rod 132 can prevent interference with the items in the storage area 118 during the movement of the lid 120.

Referring to FIGS. 4-6, the body 110 includes a second receiving groove 116 for receiving the second guiding rod 134. When the lid 120 is in the first position P1, the second guiding rod 134 can be fully accommodated in the second receiving groove 116, providing protection for the second guiding rod 134 and giving the console 100 an aesthetic appearance. The second receiving groove 116 has an opening formed on the top surface of the body 110 for the second guiding rod 134 to pass through when it moves.

Referring to FIG. 4, in some embodiments, the body 110 includes two second receiving grooves 116 for receiving the two second guiding rods 134. In the width direction Y, the top opening 112 is located between the two second receiving grooves 116. Thus, the second guiding rod 134 received in the second receiving groove 116 will not interfere with the top opening 112 and invade the storage chamber. Moreover, the two second receiving grooves 116 are distributed on both sides of the top opening 112 in the width direction Y, so that when the lid 120 is in the first position P1, it can smoothly close the two second receiving grooves 116. By designing the dimension of the lid 120 along the width direction Y slightly larger, the second receiving grooves 116 can also be closed. The closure of the second receiving groove 116 at the first position P1 by the lid 120 can enhance the appearance of the console 100 and reduce the chance of dust entering from the opening of the second receiving groove 116. In further embodiments, a covering member (such as a dust cover or dust ring made of rubber, soft cloth, etc.) can be provided at the opening of the second receiving groove 116 to cover the gap between the second guiding rod 134 and the second receiving groove 116 as much as possible when the second guiding rod 134 passes through the opening of the second receiving groove 116, thereby achieving dust prevention.

Referring to FIG. 4, in some embodiments, the first receiving groove 113 is spaced apart from the second receiving groove 116 in the length direction X or they have an overlap size smaller than a predetermined value. In the width direction Y, the first receiving groove 113 is located between two second receiving grooves 116. By reasonably arranging the first and second receiving grooves 113 and 116 in the length direction X and/or width direction Y, the possibility of mutual interference between the first guiding rod 132 and the second guiding rod 134 is prevented.

Referring to FIG. 4, in some embodiments, the dimension X2 of the first receiving groove 113 is smaller than the dimension X3 of the second receiving groove 116 in the length direction X. As mentioned earlier, the structural design of the first guiding rod 132, which includes the arc-shaped segment 131, allows for less interference between it and the body 110 during movement relative to the second guiding rod 134 in the form of a straight rod. Therefore, in the length direction X, the dimension of the first receiving groove 113 can be smaller than that of the second receiving groove 116. The second receiving groove 116 can form an elongated opening extending along the length direction X on the top surface of the body 110.

In some embodiments, the joints between the guiding assembly 130 and the lid 120 (including the first engagement end 135 of the first guiding rod 132 and the second engagement end 139 of the second guiding rod 134) may be provided with covering members or coating, so as to have a good appearance when these joints are exposed.

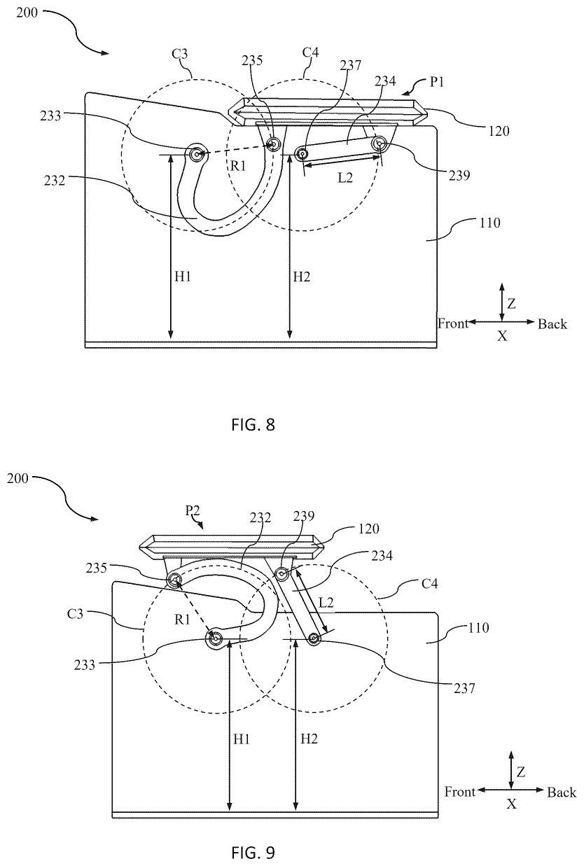

FIGS. 8 and 9 show a console 200 according to another embodiment of the present disclosure. For the sake of simplicity, components in the console 200 that are identical or similar to those in the console 100 are assigned the same or similar numbers. FIGS. 8 and 9 respectively show the console 200 in the first position P1 and the second position P2. Referring to FIGS. 8 and 9, a first guiding rod 232 moves along an arc-shaped path consistent with circle C3 around a first pivot end 233, and a first engagement end 235 of the first guiding rod 232 is engaged to the lid 120. A second guiding rod 234 moves along an arc-shaped path consistent with circle C4 around a second pivot end 237, and a second engagement end 239 of the second guiding rod 234 is engaged to the lid 120. Referring to FIGS. 8 and 9, in some embodiments, the first pivot end 233 and the second pivot end 237 may be arranged at the same height. For example, the height H1 at which the first pivot end 233 of the first guiding rod 232 is located is equal to the height H2 at which the second pivot end 237 of the second guiding rod 234 is located. The height H1 can be the vertical distance between the first pivot end 233 and the bottom of the body 110, such as the spacing in the height direction Z. The height H2 can be the vertical distance between the second pivot end 237 and the bottom of the body 110, such as the spacing in the height direction Z. The second guiding rod 234 may have a length L2 equal to the radius R1 of the arc-shaped section of the first guiding rod 232, and R1 may be equal to the distance between the first pivot end 233 and the first engagement end 235 of the first guiding rod 232. The line connecting the first pivot end 233 and the first engagement end 235 of the first guiding rod 232 may be parallel to the second guiding rod 234. Through such arrangement, the first engagement end 235 of the first guiding rod 232 and the second engagement end 239 of the second guiding rod 234 can move synchronously along an arc-shaped path centered on two circles (such as circle C3 and circle C4) with the same height and equal radius, which is beneficial for keeping the lid 120 horizontal during the movement and reducing the possibility of the lid 120 tilting.

It should be appreciated that by designing the first guiding rod and the second guiding rod to rotate around their respective ends, it is possible to conveniently and one-step guide the lid to move between the first position and the second position, which has relative displacement in the length and height directions of the vehicle relative to the first position. By designing the first guiding rod with the arc-shaped section that can move along the arc-shaped path that is concentric with the arc-shaped section, interference between the first guiding rod and the body of the console can be minimized to prevent the first guiding rod from invading the storage chamber and storage area. By arranging the top opening, the first receiving groove, the second receiving groove, and storage area in a reasonable position, the possibility of mutual interference between every two can be prevented.

The above-mentioned embodiments are possible examples of implementations of the present disclosure and are given only for the purpose of enabling those skilled in the art to clearly understand the principles of the disclosure. It should be understood by those skilled in the art that the above discussion to any embodiment is only illustrative, and is not intended to imply that the disclosed scope of the embodiments of the present disclosure (including claims) is limited to these examples; and under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, enhancement, etc. made within the spirit and principle of the embodiment of the invention shall be included in the scope of protection claimed by the invention.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A console for a vehicle, the console comprising:
a body with a top opening;
a lid configured to move between a first position, in which the top opening is closed, and a second position, in which the top opening is at least partially exposed; and
a guiding assembly engaged between the body and the lid, wherein the guiding assembly includes a first guiding rod and a second guiding rod that are spaced apart, and the first guiding rod has an arc-shaped segment and is configured to pivot around a first pivot end to move the lid from the first position to the second position.

2. The console according to claim 1, wherein the first guiding rod has an approximately U-shaped cross-section.

3. The console according to claim 1, wherein the arc-shaped segment is configured to move along an arc-shaped path that is at least partially consistent with the arc-shaped segment.

4. The console according to claim 1, wherein the arc-shaped segment has a central angle in the range of about 70 degrees to about 90 degrees.

5. The console according to claim 1, wherein the body comprises a first receiving groove for receiving the first guiding rod, and the first receiving groove is spaced apart from the top opening in a length direction of the vehicle.

6. The console according to claim 5, wherein the first receiving groove has a first opening with a dimension smaller than a dimension of the first receiving groove in the length direction.

7. The console according to claim 5, wherein the body comprises a second receiving groove for receiving the second guiding rod, and the first receiving groove is spaced apart from the second receiving groove in the length direction or the first receiving groove and the second receiving groove have an overlapping size smaller than a predetermined value.

8. The console according to claim 7, wherein the first receiving groove has a dimension smaller than a dimension of the second receiving groove in the length direction.

9. The console according to claim 7, wherein the guiding assembly comprises two second guiding rods arranged opposite each other in a width direction of the vehicle.

10. The console according to claim 9, wherein the body comprises two second receiving grooves for receiving the two second guiding rods, and the top opening is located between the two second receiving grooves in the width direction.

11. The console according to claim 10, wherein the first receiving groove is located between the two second receiving grooves in the width direction.

12. The console according to claim 7, wherein the lid is configured to close the first receiving groove and the second receiving groove when in the first position.

13. The console according to claim 7, further comprising covering members provided at the openings of the first receiving groove and the second receiving groove.

14. The console according to claim 1, wherein the second guiding rod is a straight rod and configured to pivot around a second pivot end, and the first pivot end of the first guiding rod and the second pivot end of the second guiding rod are arranged at the same height.

15. The console according to claim 14, wherein the second guiding rod has a length equal to a radius of the arc-shaped segment of the first guiding rod.

16. The console according to claim 1, further comprising a driving mechanism for promoting movement of the guiding assembly and a deceleration mechanism connected between the driving mechanism and the guiding assembly.

17. The console according to claim 1, wherein the lid comprises a base panel and a side panel pivotably connected to the base panel.

18. The console according to claim 1, wherein a cushioning component is provided at a bottom of the lid.

19. The console according to claim 1, further comprising a storage area spaced apart from the lid, and the arc-shaped segment does not interfere with items in the storage area during the movement of the lid.

20. A vehicle comprising:
a cabin interior; and
a console located in the cabin interior, the console comprising:
a body with a top opening;
a lid configured to move between a first position, in which the top opening is closed, and a second position, in which the top opening is at least partially exposed; and
a guiding assembly engaged between the body and the lid, wherein the guiding assembly includes a first guiding rod and a second guiding rod that are spaced apart, and the first guiding rod has an arc-shaped segment and is configured to pivot around a first pivot end to move the lid from the first position to the second position.
